(19) United States
(12) Patent Application Publication
(10) Pub. No.: US 2017/0358273 A1
(43) Pub. Date: Dec. 14, 2017

(54) SYSTEMS AND METHODS FOR RESOLUTION ADJUSTMENT OF STREAMED VIDEO IMAGING

(71) Applicant: YEN4KEN, INC., Princeton, NJ (US)

(72) Inventors: Sumit Negi, Bangalore (IN); Kuldeep Yadav, Haryana (IN); Om D. Deshmukh, Bangalore (IN)

(73) Assignee: YEN4KEN, INC., Princeton, NJ (US)

(21) Appl. No.: 15/178,909

(22) Filed: Jun. 10, 2016

(51) Int. Cl. G09G 5/00; G06T 3/40

(52) U.S. Cl. CPC G09G 5/003; G06T 3/40; G09G 2340/0407

(57) ABSTRACT

An image display system and method dynamically adjusts a resolution of a streamed image corresponding to determined visual saliency scores of the streamed image. A viewer display, a resolution adaptation engine and a visual saliency score calculation engine are included. The visual saliency score engine calculates a relative visual attention effort by a viewer to selected segments of the streamed image and includes a first processor for receiving a first signal representative of image content in a selected segments, for receiving a second signal representative of predetermined cues of visual saliency to the viewer, and for sending out a signal representative of identified cues in the selected segment; a saliency score calculator for determining a score representative of the relative visual attention effort for the identified cues and for outputting a visual saliency score signal indicative of the relative visual attention effort; and, a second processor to provide a resolution adjustment signal to the resolution adaptation engine.

### TECHNICAL FIELD

The presently disclosed embodiments are directed to dynamic adaptation of streaming rates for educational videos based on a visual segment metric, selectively combined with user profile information. It finds particular application in systems and methods for automated real time visual adaptation of video streaming.

### BACKGROUND

The growth of Massive Open Online Courses (MOOCs) is considered one of the biggest revolutions in education in recent times. MOOCs offer free online courses delivered by qualified professors from world-known universities and are attended by millions of students remotely. MOOCs are particularly important in developing countries such as India, Brazil, etc. Many of these countries face acute shortages of quality instructors, so that students who may rely on MOOCs for their educational instructor, often suffer a diminished understanding of the MOOCs themselves, and can be unreliable as employable graduates. For instance, studies have shown that only about 25% of students are industry employable among all the graduating engineering students per year from India. Such a low percentage generates an interesting question whether high-quality content produced by MOOCs can be used as a supplement in addition to classroom teaching by the instructors in developing economies, which may potentially help in increasing the quality of education. A common problem in education relying heavily on MOOCs is that students are not able to consume the MOOC content directly due to a variety of reasons such as a limited competency in English language, little relevance to syllabi, and lack of motivation as well as awareness. Hence, there is a need to condition or transform existing MOOC content to achieve enhanced efficacies in communication and understanding before it can be reliably used as a primary education tool.

The bulk of the MOOC material is in the form of audio/video content. There is a need to improve the clarity and efficiency of communication of such content to better improve the educational experience.

In such a typical video streaming system, the video is streamed at a system-defined or user-selected resolution often related to user or device profile information. The problem exists that such preselected resolution might not be optimal for the particular content in the video. For example, streaming a video at a high resolution results in bandwidth wastage (a major constraint for mobile devices or in underdeveloped/developing countries where bandwidth is a scarce resource). On the other hand, streaming a video at low resolution might result in loss of “visual clarity,” which could be of prime importance for certain segments in the video. More particularly, when the video segment displays a diagram, image, or slide with low font text, handwritten text, etc., the reduced clarity can make it very difficult for the student to properly appreciate the displayed image and thus grasp the intended lesson. While certain segments of the video could be acceptably streamed at a lower resolution, certain segments (hereinafter referred to as “visually salient segments”) often require higher resolution transmission and display.

There is thus a need for an automated way of calculating or determining the visual saliency scores for video segments and then utilizing these scores for dynamic adaptation of streaming rates for transmitted educational videos.

### SUMMARY

The presently disclosed embodiments provide a system and mechanism for calculating the visual saliency score of video segments in a streamed transmission. The visual saliency score captures the likely visual attention effort of a viewer/student of segments of the video that is required to comprehensively view the certain video segment. The saliency score calculator uses speaker cues (e.g., verbal or use-appointed items), and image/video cues (e.g., dense text/object regions, or “clutter”) to compute the visual attention effort required. The saliency score calculator, which works at a video segment level, uses these information/cues from multiple modalities to derive the saliency score for video segments. Video segments that contain dense printed text, handwritten text, blackboard activity are given higher saliency scores than segments where the instructor is presenting without visual props, answering queries, or displaying slides with large font size. Segments with high saliency score are streamed at a higher resolution as compared to those with lower scores. This ensures effective use of bandwidth while still guaranteeing and ensuring high visual fidelity to segments that matter the most. The subject embodiments dynamically adapt the resolution of a streaming video based on the visual saliency scores and additionally imposed constraints (e.g., device and bandwidth). The desired result being that segments with high visual saliency scores are displayed at a higher resolution as compared to other video segments.

According to aspects illustrated herein, there is provided an image display system for dynamically adjusting the resolution of a streamed video image corresponding to determined visual saliency of a streamed image segment to a viewer. The system comprises a resolution adaptation engine for adjusting the resolution of a display, and a visual saliency score calculation engine for calculating a relative visual attention effort by the viewer to selected segments of the streamed image. The visual saliency score calculation engine includes a first processor for receiving a first signal representative of image content in the selected segments, and a source of signals representing predetermined cues of visual saliency to the viewer for relative identification of higher visual saliency. A second processor in communication with the score calculation processor provides an output contrast signal to the resolution adaptation engine to adjust the resolution of the video stream for the corresponding segment.

### BRIEF DESCRIPTION OF THE FIGURES

FIG. 1 is a block diagram of a system embodiment;

FIG. 2 is a block diagram of a visual saliency score calculation engine;

FIG. 3 is a flowchart of a process for practicing the subject embodiments.

### DETAILED DESCRIPTION

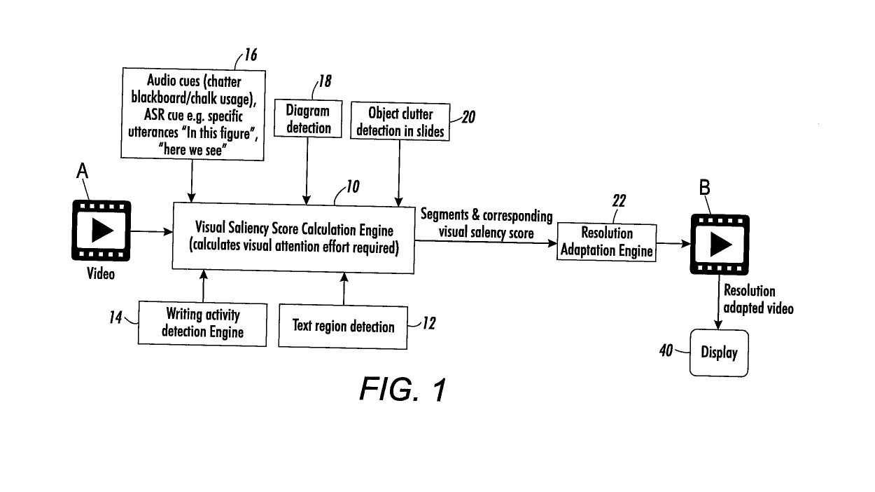

The subject embodiments comprise an image display system and process for dynamically adjusting a resolution of a streamed image A based on a determined visual saliency of the streamed image to a viewer/student to generate a resolution adapted video image B on a display device 40. With reference to FIG. 1, an audio/video input A to the visual saliency score engine 10 is analyzed by the engine 10 to identify segments therein that would be better presented to the viewer in a higher resolution. More particularly, the engine 10, which is typically comprised of a combination of hardware and software, recognizes by sensed determination or a manual input, a first resolution of the input audio/video A. The engine 10 will then use a host of features (described below) to calculate a saliency score for selected segments of the video A. The score is indicative of whether the associated video segment should be transmitted at a higher resolution. In the disclosed embodiments, a higher salient score will correspond to a higher resolution transmission, although the precise relative scoring utilized is merely subjective. It is more important that the engine derive a calculation representative of a relative visual attention effort by the viewer to corresponding segments of the streamed video A. FIG. 1 shows numerous kinds of cues that can be suggestive of enhanced resolution adaptation. These include text region detection 12, writing activity detection 14, selected audio detection 16, diagram detection 18 and object clutter detection 20.

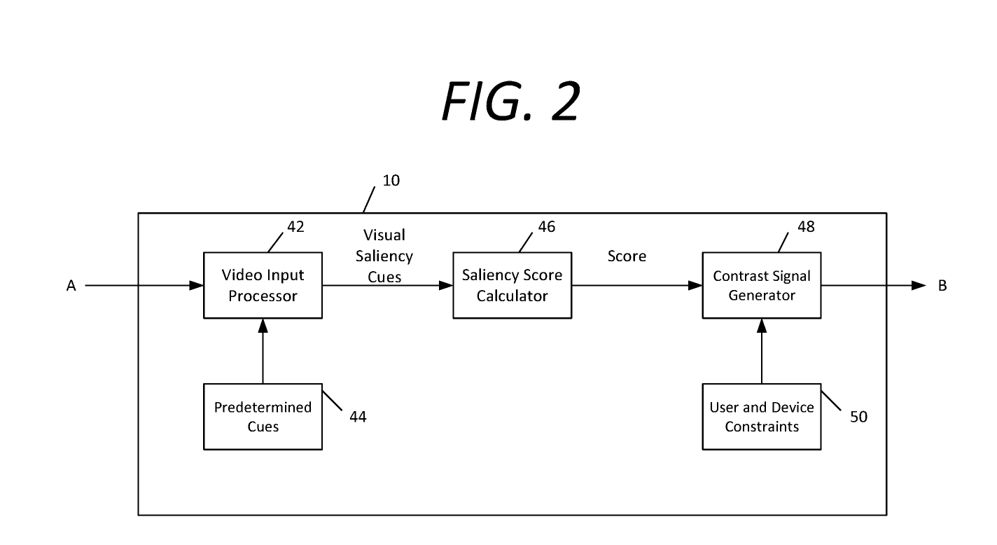

Text region detection 12 comprises detecting textual regions in a slide/video segment by identifying text-specific properties that differentiate the text from the rest of the scene of a video segment. A processing component 42 (FIG. 2) uses a combination of texture-like statistical measures to detect if a video segment or frame has text regions. Measures that use gray-level histograms, edge density and angles (text regions have a high density of edges) and the like are employed to compute that the segment has a high probability of comprising a text region. Video segment features are transformed to signal representations, which signal representations can be compared against predetermined signal measurements or cues 44 to determine the presence of the text in the segment.

Writing activity detection is included in processing module 42 to identify a video segment that has a “writing activity” such as where an educator is writing on a display, slide or board. Known activity detection techniques are used for this task. As most educational videos are generated using a static camera this is a relatively simpler problem than when compared to a moving camera. Techniques such as Gaussian Mixture Model (GMM) and segmentation by tracking are typically employed. These techniques may use a host of features to represent and/or model the video content ranging from local descriptors (SIFT, HOG, KLT, shape-based to body modeling, 2D/3D models). [SIFT=Scale Invariant Feature Transform, HOG=Histogram of oriented Gradients, KLT=Kanade-Lucas-Tomasi (KLT), 2D/3D=2 dimensional and 3 dimensional] Such an activity detection system processor 42 enables one to temporarily segment a long egocentric video of daily-life activities into individual activities and simultaneously classify them into their corresponding classes. The novel multiple instance learning (MIL) based framework is used to learn egocentric activity classifier. The embodied MIL framework learns a classifier based on the set of actions which are common to what activities belong to a particular class in the training data. This novel classifier is used in a dynamic program (DP) framework to jointly segment and classify a sequence of egocentric activities. Using this embodied approach significantly outperforms a support vector machine based joint segmentation and classification baseline on the activities of a daily living data set (ADL=Activities of Daily Living dataset). The result is thus again a signal processing system where measured features of the video segment are compared against predetermined signal standards 44 indicating a writing activity, and where such activity is present, enhanced resolution of the video imaging is effected.

Audio detection 16 is additionally helpful in calculating a salient score. Audio features indicating chatter, discussion and chalkboard use can be incorporated. Moreover, verbal cues derived from ASR [Automatic Speech Recognition] output can be used to detect the start of high saliency video segments (e.g., “we see here,” “if you look at the diagram,” “in this figure,” and the like). Audio cues in conjunction with visual feature cues can significantly improve the reliability and accuracy of the saliency score calculation. Known voice processing software can be employed to identify such cues.

Diagram/figure detection 18 in processor 42 comprises combining features extracted from the input video visual and audio modalities to infer the location of figures/tables/equations/graphs/flowcharts (collectively “diagram”) in a video segment that is based on a set of labeled images. Two different models, shallow and deep, classify a video frame in an appropriate category that a particular frame in the segment contains a diagram.

Shallow Models: In this scenario, SIFT (scale invariant feature transform) and SURF (speeded up robust features) are extracted from the training images to create a bag-of-words model on the features. For example, 256 clusters in the bag-of-words model can be used. Then a support vector machine (SVM) classifier is trained using the 256 dimensional bag-of-features from the training data. For each un-labelled image (non-text region) the SIFT/SURF features are extracted and represented using the bag-of-words model created using the training data. The image is then fed into the SVM classifier to find out the category of the video content.

Deep Models: convolutional neural networks (CNN) are used to classify non-text regions. CNNs have been extremely effective in automatically learning features from images. CNNs process an image through different operations such as convolution, max-pooling etc. to create representations that are analogous to human brains. CNNs have recently been very successful in many computer vision tasks, such as image classification, object detection, segmentation etc. Motivated by that, CNN for classification is used to determine the anchor points. An existing convolution neural network called “Alexnet” is used to fine-tune the training images that are collected to create an end-to-end anchor point classification system. While fine-tuning the weights of the top layers of the CNN are modified while keeping the weights of the lower layers similar to the initial weights.

Object clutter detection 20 in a segment is a specific processing component the processor 42 where it is estimated how much information is present in the video frame (or slide). This estimation is performed with respect to a number of objects present in an amount of text. This estimation can be performed by specific image processing module that detects the percentage of region in a given slide which contains written text, objects (such as images, diagrams).

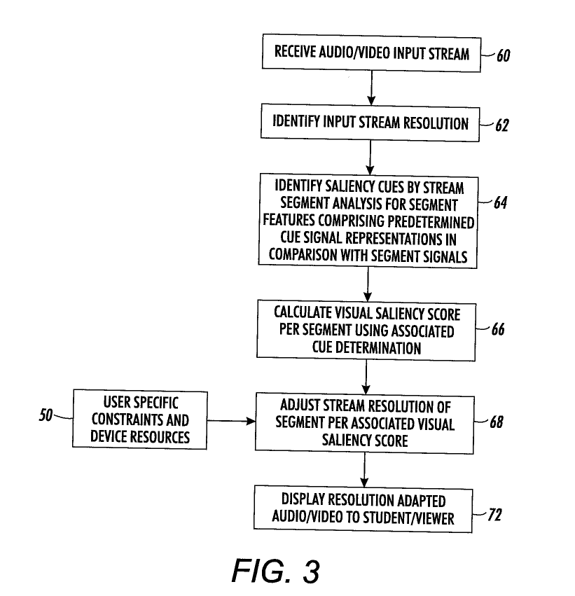

With particular reference to FIGS. 2 and 3, more detailed descriptions of the visual saliency score calculation engine 10 and processing steps of the present embodiment are described. The engine 10 receives 60 the audio video input stream A into a video input processor 42 which identifies a resolution of the input stream A and identifies visual saliency cues therein by stream segment analysis 64 to determine segment features comprising predetermined cue signal representations in relative comparison with stream segment signals. More particularly, signals representative of predetermined cues such as those identified in FIG. 1 are used as a basis for identifying a presence of the visual saliency cues in the input segment A. A signal representative of the existence of the visual saliency cues is input into a saliency score calculator 46 to calculate 66 a visual saliency score per segment using the associated cue determination of the input processor 42. A second processor 48 comprising a contrast signal generator receives the visual saliency score and a signal representative of user specific constraints and device resources 50 to adjust 68 the stream resolution of a segment per the associated visual saliency score and the preexisting constraints of the display device of the user/viewer/student. The signal generator 48 outputs a signal that results in resolution adjustment to the resolution adaptation engine 22 to generate the resolution adapted video B which then can be displayed 72 to a student/viewer.

The resolution adaption engine 22 includes two tasks: first, to decide the right resolution for a given video segment given its saliency score and other constraints including
a.) resource (e.g. device, bandwidth) and
b.) user specific constraints such as—environment (e.g. travelling), or differently enabled newer (e.g. low vision, hand tremors); and, second, to generate the resolution adapted video.

There are multiple ways to decide the correct resolution rate for a given video segment. One such method is to bucketize the saliency scores into a plurality of buckets and associate with each bucket a specific resolution rate. The bucket size and associated resolution rate could be different for different devices, user constraints. Once the resolution rate for each video segment has been decided the resolution adaption engine splits the video into segments (based on the resolution requirements). Each segment is then individually processed to increase/decrease the resolution rate. This can be easily achieved using existing video editing modules. The final resolution adapted video is created by stitching together these individual (resolution adjusted) video segments.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. An image display system for dynamically adjusting a resolution of an instructional image corresponding to determined visual saliency of the streamed instructional image to a viewer, comprising:
a viewer display;
a resolution adaptation engine configured to adjust the resolution of the streamed instructional image; and,
a visual saliency score calculation engine configured to calculate a relative visual attention effort by the viewer to selected segments of the streamed instructional image comprising:
a first processor configured to receive a first signal representative of image content in the selected segments and a second signal representative of predetermined cues of visual saliency to the viewer, and configured to send out a signal representative of identified cues in the selected segment;
a saliency score calculator configured to determine a score representative of the relative visual attention effort for the identified cues and configured to output a visual saliency score signal indicative of the relative visual attention effort; and,
a second processor in communication with the calculator configured to provide a resolution adjustment signal to the resolution adaptation engine; and,
wherein the resolution adaptation engine in response to the resolution adjustment signal is configured to generates a second resolution adapted signal to the viewer display.

2-10. (canceled)

11. A process for dynamically adjusting resolution for an instructional video, comprising:
analyzing the instructional video to identify one or more segments of the instructional video that would be better presented in higher resolution;
calculating a visual saliency score for the one or more segments of the instructional video using instructional semantics, wherein the instructional semantics comprise objects, texts, audio, writing activity, and diagrams within the one or more segments of the instructional video; and
dynamically adjusting the resolution of the one or more segments of the instructional video based on the visual saliency score.

12. The process of claim 11, further comprising:
detecting textual regions in the one or more segments of the instructional video to identifying the texts.

13. The process of claim 12, wherein the detecting of the textual regions comprises detecting gray-level histograms, edge density, and angles to determine if the one or more segments of the instructional video has a high probability of textual regions.

14. The process of claim 11, further comprising:
identifying the writing activity within the one or more segments of the instructional video, when a person within the video is writing on a display, slide, or board.

15. The process of claim 14, wherein the identifying of the writing activity comprises using a multiple instance learning (MIL) based framework to identify actions that are common to the writing activity.

16. The process of claim 11, further comprising:
identifying the audio having high resolution requirements within the one or more segments of the instructional video, wherein
the identifying of the audio comprising detecting verbal cues derived from automatic speech recognition output, and the verbal cues comprises emphasized phrases, repeated phrases, and indicative pre-determined phrases.

17. The process of claim 11, further comprising:
detecting visual cues comprises text regions, writing activities, diagram and figures, and clutter to for each of the one or more segments of the instructional video.

18. The process of claim 11, further comprising:
combining features extracted from the one or more segments of the instructional video to identify location of the diagrams.

19. The process of claim 11, further comprising:
detecting a number of objects within the one or more segments of the instructional video, wherein the detecting of the number of objects comprises detecting a percentage of the objects as compared to texts within the one or more segments of the instructional video.

20. A process for adjusting resolution of a streamed video, comprising:
identifying visual saliency cues in one or more segments of the streamed video;
calculating a visual saliency score for each of the one or more segments of the streamed video, wherein the calculating of the visual saliency score is based on the visual saliency cues identified within the one or more segments of the streamed video;
dynamically adjusting the resolution for each of the one or more segments of the stream videos according to the visual saliency score of each of the one or more segments of the stream videos; and
outputting an adapted video to be displayed to a user, the adapted video comprising the adjusted resolution.
